(19) United States
(12) Patent Application Publication
(10) Pub. No.: US 2026/0322200 A1
(43) Pub. Date: Oct. 15, 2026

(54) WINDING, COMPONENT FOR AN ELECTRIC MACHINE, AND METHOD FOR PRODUCING A WINDING

(71) Applicant: ZF FRIEDRICHSHAFEN AG, Friedrichshafen (DE)

(72) Inventors: Kaijun XU, Schonungen (DE); Stefan REUTER, Hammelburg (DE); Robin MICHELBERGER, Schweinfurt (DE)

(21) Appl. No.: 19/099,371

(22) PCT Filed: Aug. 2, 2023
(86) PCT No.: PCT/EP2023/071380

§ 371 Date: Jan. 28, 2025

(30) Foreign Application Priority Data
Aug. 3, 2022 (DE) 10 2022 208 027.0

(51) Int. Cl. H02K 3/28; B60K 1/00; B60K 17/04; H02K 15/36

(52) U.S. Cl. CPC H02K 3/28; H02K 15/36; B60K 1/00; B60K 17/04

(57) ABSTRACT

A winding is provided for a component of an electric machine that includes an annular lamination stack with slots extending axially through the lamination stack for receiving partial strands of the winding in radially adjacent winding layers. A first twist direction and a second twist direction are associated with a radially innermost inner layer of the winding layers, and a radially outermost outer layer of the winding layers. The first twist direction is associated with at least one intermediate layer of the winding layers arranged radially between the inner layer and the outer layer, and the second twist direction is associated with at least one further intermediate layer of the winding layers arranged radially between the inner layer and the outer layer. A first partial strand of the winding exiting from the intermediate layer is interconnected with a second partial strand of the winding entering in the further intermediate layer.

### CROSS REFERENCE TO RELATED APPLICATIONS

This is a U.S. national stage of Application No. PCT/EP2023/071380 filed Aug. 2, 2023. Priority is claimed on German Application No. DE 10 2022 208 027.0 filed Aug. 3, 2022, the contents of which are incorporated herein by reference.

### BACKGROUND OF THE INVENTION

### 1. Field of the Invention

The present disclosure is directed to a winding, a component for an electric machine, an electric machine, a transmission device, an electric axle drive, a motor vehicle, and a method for producing a winding.

### 2. Description of the Related Art

Electric machines may include components with windings comprising, for example, copper wires, for conducting electrical energy for generating magnetic fields. The chording of such windings, for example, flat wire windings, can be implemented based on additional interconnection elements or lost and additional motion on a complete winding layer of the component.

### SUMMARY OF THE INVENTION

Against this background, one aspect of the present invention provides an improved winding, an improved component for an electric machine, an improved electric machine, an improved transmission device, an improved electric axle drive, an improved motor vehicle, and an improved method for producing a winding according to the main claims.

The winding presented herein can advantageously enable a reduced axial height, and a maximum saving of copper weight in the winding head can be realized.

In a winding for a component of an electric machine, the component comprises an annular lamination stack with a plurality of slots axially extending through the lamination stack for receiving partial strands of the winding in a plurality of winding layers arranged radially adjacent one another. A first twist direction and a second twist direction which differs from the first twist direction are associated with a radially innermost inner layer of the winding layers, and the first twist direction and second twist direction are associated with a radially outermost outer layer of the winding layers. The first twist direction is associated with at least one intermediate layer of the winding layers that is arranged radially between the inner layer and the outer layer, and the second twist direction is associated with at least one further intermediate layer of the winding layers that is arranged radially between the inner layer and the outer layer. A first partial strand of the winding exiting from the intermediate layer is interconnected with a second partial strand of the winding entering in the further intermediate layer.

The electric machine can be, for example, an electric drive motor or other electric machine, for example, for a vehicle. The electric machine can comprise various components, such as a rotor and a stator, for example. The component, for example, an annular stator, can be formed from a plurality of individual laminations as a lamination stack through which the slots for receiving the partial strands of the winding extend. The slots can be numbered consecutively along the circumference of the lamination stack so that each slot may be assigned a unique position. Each of the slots can receive a plurality of partial strands which can be arranged radially adjacent in the slot. The quantity of partial strands, which can be received by a slot, can correspond to a quantity of winding layers. Accordingly, the winding layers can make up different portions of the slots. The winding can be, for example, a flat wire winding, the individual partial strands of which may be formed, for example, as hairpins or hairpin wires, i.e., as electrically conductive wires with a hairpin-like geometry. The individual partial strands can be inserted, for example, into the corresponding slots in the lamination stack and interconnected with one another at a twist side of the winding. “Interconnection” can refer, for example, to an electrically conductive connection or a mechanical coupling or gluing. The individual partial strands can be arranged partially in one slot and partially in another slot, and the slots may vary with respect to their radial position along a circumference of a winding layer of the lamination stack and, additionally or alternatively, in the selected winding layer such that every partial strand can span a determined portion of the component. If the lamination stack has, for example, four winding layers, the first partial strand of the winding can be arranged, for example, with a first input portion in a winding layer, for example, the inner layer, can span a partial area of the lamination stack at a crown inside of the winding and can be arranged in the intermediate layer with a first output portion arranged substantially parallel to the first input portion so as to be interconnected with the second partial strand at a twist side of the winding opposite the crown side. The immediate layer can be, for example, a winding layer arranged adjacent the inner layer so that the first partial strand can at least partially span two winding layers, for example. The first partial strand is interconnected with the second partial strand, for example, to enable a flow of electric current from the first partial strand to the second partial strand. The second partial strand is arranged, for example, with a second input portion in the further intermediate layer, which can be, for example, a winding layer adjacent the prior intermediate layer. Similar to the first partial strand, the second partial strand can also span a further partial area of the lamination stack, for example, in that a second output portion of the second partial strand, which second output portion is substantially parallel to the second input portion, can be arranged in another winding layer, for example, in the outer layer. In order to enable or facilitate an interconnection of the partial strands, different twist connections running opposite one another, for example, are associated with the individual winding layers of the lamination stack. A twist direction can be understood as a direction or an angle in which an end portion of a hairpin wire can project out of the lamination stack. Accordingly, for example, two wire ends with opposite twist directions can be interconnected with one another, i.e., for example, twisted together. In this way, the first partial strand is interconnected with the second partial strand on the twist side in the winding presented herein. Since the first twist direction is associated with the intermediate layer and the second twist direction is associated with the further intermediate layer, the partial strands can project out of the lamination stack at angles on the twist side which are inclined relative to one another and can advantageously be interconnected without a great expenditure of force. Since both twist directions are associated with the inner layer and the outer layer, partial strands which are arranged in these winding layers can advantageously be interconnected inside of the respective winding layer as well as with other winding layers with different twist directions. In contrast, twist directions running opposite one another are associated with the intermediate layer and the further intermediate layer in order to optimize an interconnection between the intermediate layers in an advantageous manner. A compact interconnection and a reduced winding head height can advantageously be achieved by a layer-spanning interconnection of the partial strands of the winding over different winding layers of the lamination stack. Accordingly, the installation space requirement of the entire component and the copper weight can be minimized overall.

According to an embodiment form, the first partial strand can have a first input portion, a first output portion and a first connection portion connecting the first input portion and first output portion. The first input portion of the first partial strand can be arranged in a first input slot of the slots at a first input position of a first input layer of the winding layers, and the first output portion can be arranged in a first output slot of the slots at a first output position of the intermediate layer. The first input layer can correspond to a winding layer of the winding layers differing from the intermediate layer. The first input position can be spaced from the first output position along a circumference of a winding layer, and the first output portion can be interconnected with the second partial strand. For example, the respective partial strands can be so-called hairpins, i.e., wires with a hairpin-like geometry. A first input portion of the first partial strand and a first output portion of the first partial strand may be understood as two substantially parallel legs of the hairpin wire which can be connected to one another via the connection portion. These legs can be arranged in different slots at different radial positions of the lamination stack. For example, the first input portion can be arranged in the input slot of the input layer at a first input position. The input layer can be, for example, the inner layer or the outer layer in order to connect the partial strand, for example, to a current source at that location. The input portion can be guided from the twist side of the winding through the input slot to the crown side. The first connection portion can produce a connection along the crown side to the first output portion arranged in the output slot in the intermediate layer. The output slot can be arranged to be spaced from the input slot along a circumference of the intermediate layer. For example, six other slots can be arranged between the input slot and the output slot so that the connection portion can span a radial distance between the winding layers and also a plurality of other slots along the circumference. The second partial strand and further partial strands can be similarly formed and arranged similar to the first partial strand at different positions. A winding that extends uniformly around the entire lamination stack can advantageously be achieved in this way.

According to one aspect of the invention, the first input layer and the intermediate layer can be arranged adjacent one another. For example, the first input layer can be the inner layer of the lamination stack. Correspondingly, the first partial strand can form a partial winding of the winding which partially surrounds the inner layer and the adjacently arranged intermediate layer. Similarly, the second partial strand, for example, can enter in the further intermediate layer which is, for example, arranged adjacent the prior intermediate layer and can exit in the outer layer which is, for example, again arranged adjacent the further intermediate layer in order to connect each intermediate layer with a winding layer adjacent to it.

According to one aspect of the invention, the further intermediate layer can be arranged between the first input layer and the prior intermediate layer. For example, the first partial strand can enter in the outer layer of the lamination stack, traverse the further intermediate layer, which is arranged, for example, adjacent the outer layer, on the crown side of the winding, and exit in the intermediate layer which is arranged, for example, between the further intermediate layer and the inner layer. From there, the first partial strand can be interconnected with the second partial strand which, for example, enters in the further intermediate layer. Similar to the first partial strand, the further partial strand can traverse the intermediate layer on the crown side and exit again in the inner layer of the lamination stack.

According to a one aspect of the invention, the second partial strand can have a second input portion, a second output portion and a second connection portion connecting the second input portion to the second output portion. The second input portion can be arranged in a second input slot at a second input position of the further intermediate layer and be interconnected with the first output portion of the first partial strand, and the second output portion can be arranged in a second output slot at a second output position of the outer layer or of the inner layer. The second input position can be spaced from the second output position along a circumference of a winding layer, and the second output portion can be connected with a further first input portion of a further partial strand. The second partial strand can be guided, for example, similar to the first partial strand, so as to span the intermediate layers radially and also spaced apart with respect to the circumference. On the other hand, the interconnection of the second partial strand and the further first partial strand can be carried out inside of a winding layer, for example, inside of the inner layer or the outer layer.

According to a one aspect of the invention, the further first input portion of the further first partial strand can be arranged in a further first input slot at a further first input position. The further first input position can be spaced from the second output position along the circumference of one of the winding layers. In contrast to the layer-spanning interconnection of the first partial strand and second partial strand, an interconnection between the second partial strand and the further first partial strand, for example, can be carried out inside of the inner layer or outer layer, since both the first twist direction and second twist direction are associated with these winding layers. The second output portion and the further first input portion can span a plurality of slots or a plurality of positions, for example, along the same winding layer.

According to one aspect of the invention, the winding can comprise a plurality of first partial strands and second partial strands which can be interconnected with one another in an alternating manner. The arrangement of input portions and output portions and the interconnection of the individual partial strands can be carried out in a layer-spanning manner or within the inner layer or outer layer and follow the above-described pattern of the first partial strand and second partial strand and of the second partial strand and further first partial strand. In this way, the winding can advantageously be produced with a reduced winding head height, low installation space requirement and minimum expenditure of material.

Further, a component is presented for an electric machine with a variant of the previously presented winding. The component further comprises an annular lamination stack with a plurality of radially adjacently arranged winding layers, each winding layer comprising a plurality of slots extending axially through the lamination stack for receiving partial strands of the winding. As a result of this combination, the advantages described above can advantageously be realized in an optimal manner.

According to one aspect of the invention, the component can comprise three of the above-described windings. A phase for each winding can be carried in each of the windings, for example, all of which can be wound according to the same winding scheme. In this way, a compact component with optimized wiring of the individual phases can advantageously be realized.

An electric machine can comprise an aforementioned component, which can be constructed either as a stator or as a rotor. For example, the component can comprise three of the aforementioned windings.

The electric machine is suitable, for example, for an electric axle drive. Such an electric axle drive for a motor vehicle comprises at least one aforementioned electric machine, a transmission device and a power converter. The power converter can be constructed, for example, as an inverter. An electric current required for operating the electric machine can be supplied using the power converter. A torque provided by the electric machine can be transformed into a drive torque for driving at least one wheel of the motor vehicle using the transmission device. The transmission device can have a transmission for reducing the speed of the electric machine and, optionally, a differential.

Correspondingly, a motor vehicle can comprise an aforementioned electric machine and, additionally or alternatively, an aforementioned electric axle drive.

Further, a method is provided for producing a variant of the previously presented winding for a variant of the previously presented component. The method includes a step of guiding the first partial strand of the winding through the intermediate layer, the first twist direction of the winding being associated with the intermediate layer. In addition, the method includes a step of further guiding the second partial strand through the further intermediate layer, a second twist direction of the winding which differs from the first twist direction being associated with the further intermediate layer. The method further includes a step of interconnecting the first partial strand and a second partial strand of the winding.

This method can be implemented, for example, in software or hardware or in a combination of software and hardware, for example, in a control device.

The solution presented herein further provides an apparatus, which is formed to carry out, actuate or implement the steps of a variant of a method presented herein in corresponding devices. The object upon which one aspect of the invention is based can also be met quickly and efficiently by this constructional variant of the invention in the form of an apparatus.

To this end, the apparatus can have at least one computing unit for processing signals or data, at least one storage unit for storing signals or data, at least one interface to a sensor or to an actuator for inputting sensor signals from the sensor or for outputting data signals or control signals to the actuator and/or at least one communications interface for inputting or outputting data which are embedded in a communications protocol. The computing unit can be, for example, a signal processor, a microcontroller or the like. The storage unit can be a flash drive, an EEPROM or a magnetic storage unit. The communications interface can be configured to input or output data wirelessly and/or via wires. A communications interface which can input or output data via wires can input these data, for example, electrically or optically from a corresponding data transmission line or can output these data in a corresponding data transmission line.

In the present case, an apparatus may be understood as an electric device which processes sensor signals and outputs control signals and/or data signals depending thereon. The apparatus can have an interface that can be hardware-based and/or software-based. In a hardware-based embodiment, the interfaces can be, for example, part of a so-called system ASIC comprising a wide variety of functions of the apparatus. However, it is also possible that the interfaces are separate integrated circuits or at least partially comprise discrete components. In a software-based embodiment, the interfaces can be software modules which are provided, for example, on a microcontroller in addition to other software modules.

Also advantageous is a computer program product or computer program with program code that can be stored on a machine-readable carrier or storage medium, such as a solid-state storage, a fixed disk storage or an optical storage and that is used for carrying out, implementing and/or actuating the steps of the method according to one of the above-described embodiment forms, particularly when the program product or program is executed on a computer or an apparatus.

### BRIEF DESCRIPTION OF THE DRAWINGS

The invention will be described in more detail by way of example referring to the accompanying drawings. The drawings show:

FIG. 1 is a schematic side view of a component of an electric machine with a winding;

FIG. 2 is a schematic top view of a component with a winding;

FIG. 3 is an oblique top view of a component with a winding;

FIG. 4 is a tabular representation of an exemplary winding scheme for a winding;

FIG. 5 is a schematic top view of a component with a winding;

FIG. 6 is a tabular representation of an exemplary winding scheme for a winding;

FIG. 7 is a schematic top view of a component with a winding;

FIG. 8 is a schematic view of a first partial strand;

FIG. 9 is a flowchart showing a method for producing a winding;

FIG. 10 is a motor vehicle; and

FIG. 11 is a block diagram illustrating an apparatus for producing a winding.

### DETAILED DESCRIPTION OF THE PRESENTLY PREFERRED EMBODIMENTS

In the following description of preferred exemplary aspects of the present invention, the same or like reference numerals are used for the elements illustrated in the various figures having similar functionality so as to avoid a repetitive description of these elements.

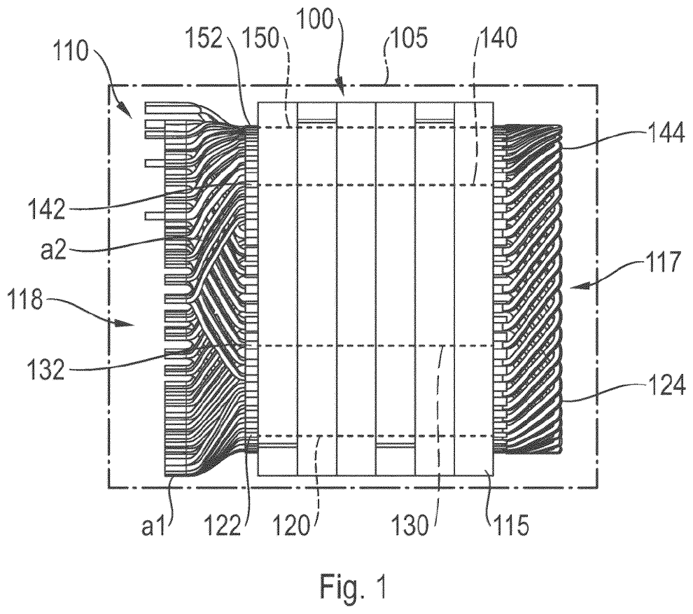

FIG. 1 shows a schematic side view of a component 100 of an electric machine 105 with a winding 110. The component 100 is formed as a stator, merely by way of exemplary, and comprises an annular lamination stack 115 with a plurality of slots axially extending through the lamination stack 115 for receiving partial strands of the winding 110 in a plurality of radially adjacently arranged winding layers.

A first twist direction and a second twist direction which differs from the first twist direction are associated with a radially innermost inner layer of the winding layers, and the first twist direction and second twist direction are associated with a radially outermost outer layer of the winding layers. The first twist direction is associated with at least one intermediate layer of the winding layers, which is arranged radially between the inner layer and the outer layer, and the second twist direction is associated with at least one further intermediate layer of the winding layers in addition to the aforementioned intermediate layer which is arranged radially between the inner layer and the outer layer. A first partial strand a1 of the winding exiting from the intermediate layer is interconnected with a second partial strand a2 of the winding 110 entering in the further intermediate layer.

The partial strands of the winding 110 are formed, merely by way of example, as flat wires for conducting a flow of electrical energy with a hairpin-like geometry and may therefore also be referred to as hairpins or hairpin wires. By way of example, every hairpin has two portions or legs which are guided in each instance through a slot of the lamination stack and are interconnected with one another at a crown side 117 of the component 100. The free ends of each hairpin wire are connectable with another wire at a twist side 118 opposite the crown side 117. Accordingly, merely by way of example, the winding 110 comprises the first partial strand a1 which is arranged with a first input portion 120 in a first input slot 122. In this exemplary embodiment, first input slot 122 is positioned at a first input position of a first input layer. Merely by way of example, the first input layer is the outer layer of the lamination stack 115, the first twist direction and the second twist direction of the winding 110 being associated with the outer layer. This means that a wire entering or exiting the outer layer is guidable to another wire along a circumference of the lamination stack 115 in two different directions and is interconnectable therewith.

In this exemplary embodiment, first input portion 120 is connected to a first output portion 130 via a first connection portion 124 at the crown side 117 of the winding 110. First output portion 130 is arranged in a first output slot 132. Merely by way of example, first output slot 132 is positioned at a first output position of the intermediate layer. The first input position is spaced from the first output position along the circumference of a winding layer.

In this exemplary embodiment, first output portion 130 is interconnected with a second input portion 140 of second partial strand a2. Merely by way of example, second input portion 140 is arranged in a second input slot 142 at a second input position of the further intermediate layer. The second twist direction of the winding 110 is associated with the further intermediate layer in order to interconnect second input portion 140 with first output portion 130. Merely by way of example, second input portion 142 is connected to a second output portion 150 via a second connection portion 144. Second output portion 150 is arranged in a second output slot 152. In this exemplary embodiment, second output slot 152 is arranged at a second output position of the inner layer, and the second input position is spaced from the second output position along a circumference of a winding layer, the second output portion 150 being interconnected with a further first input portion of a further first partial strand.

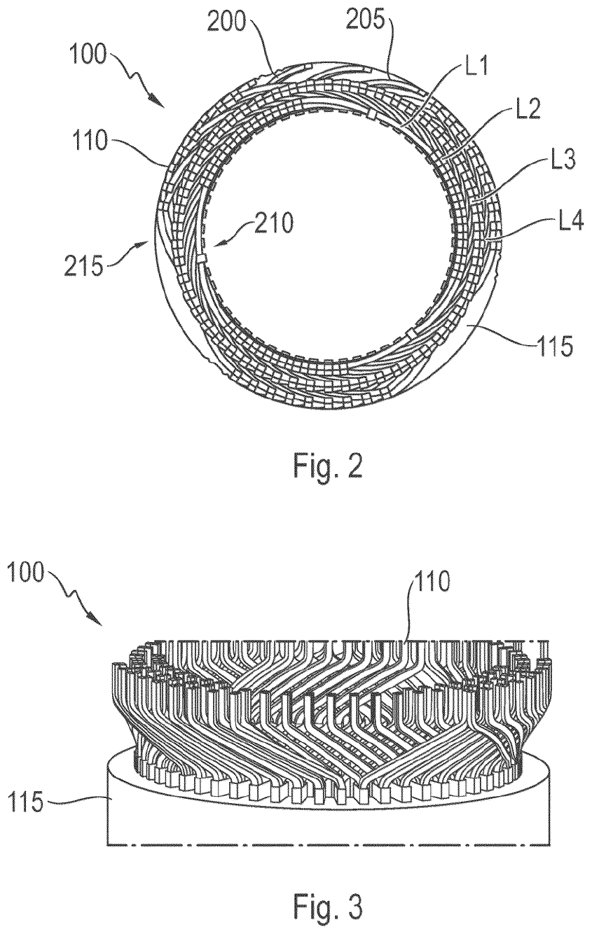

FIG. 2 shows a schematic top view of a component 100 with a winding 110 according to an exemplary embodiment. The component 100 and winding 110 shown here correspond to, or are similar to, the component and winding described in the preceding figure. Component 100 is shown in the depicted diagram from the twist side. The annular lamination stack 115 of component 100 is formed in this exemplary embodiment to receive four winding layers L1, L2, L3, L4 of, merely by way of example, three similarly wound windings 110, 200, 205. Merely by way of example, a U phase is carried in winding 110. In this exemplary embodiment, merely by way of example, a W phase is carried in a further winding 200 and, merely by way of example, a V phase is carried in an additional winding 205. The winding layers L1, L2, L3, L4 are arranged radially adjacent one another. Merely by way of example, a radially innermost inner layer L1 is arranged at an inner side 210 of winding 110. In this exemplary embodiment, an intermediate layer L2 is arranged radially adjacent inner layer L1. A further intermediate layer L3 is arranged on the radially opposite side from inner layer L1 adjacent intermediate layer L2. An outer layer L4 is again arranged adjacent further intermediate layer L3 at an outer side 215 of the winding. A first twist direction and a second twist direction which differs from the first twist direction are associated with inner layer L1, and the first twist direction and second twist direction are likewise associated with outer layer L4. Correspondingly, wires guided in these two winding layers L1, L4 are guidable with the free-standing ends on the twist side along the circumference of the winding layers in two different directions and are interconnectable with correspondingly oppositely directed wires. In contrast to the two twist directions of inner layer L1 and outer layer L4, the first twist direction is associated with intermediate layer L2, which is arranged radially between inner layer L1 and outer layer L4, and the second twist direction is associated with further intermediate layer L3.

FIG. 3 shows an oblique top view of component 100 with a winding 110. The component 100 and winding 110 shown here correspond to, or are similar to, the component and winding described in the preceding figures and are shown in this view from the twist side. Component 100 comprises an annular lamination stack 115 with a plurality of slots axially extending through lamination stack 115 for receiving partial strands of radially adjacently arranged winding layers. The slots are positioned along a circumference of a winding layer.

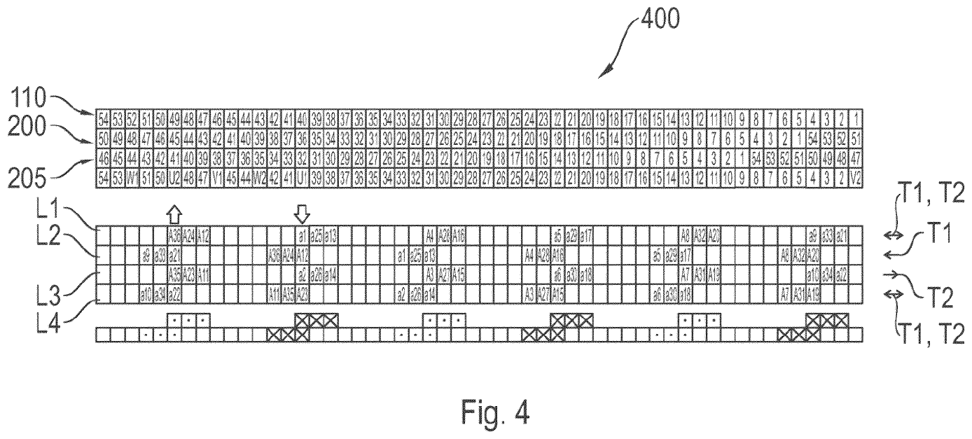

FIG. 4 shows a tabular representation of a winding scheme 400 for a winding such as has been described with reference to the preceding figures. The winding scheme 400 shown here is constructed, by way of example, for a component with a lamination stack with, for example, fifty-four slots and a respective hole number 3 for receiving a total of three windings 100, 200, 205 in which, for example, phases U, W and V can be carried. Positions 1 to 54 of the slots along the circumference of the lamination stack are indicated in the upper three rows of the table. The top row corresponds to the winding 110 carrying the U phase, the row below that corresponds to the further winding 200 carrying the W phase, and the row below that corresponds to the additional winding 205 carrying the V phase. In the fourth row, the positions of the respective connections of the individual phases are indicated, where U1 is an input of the U phase and U2 is an output of the U phase, W1 is an input of the W phase and W2 is an output of the W phase, and V1 is an input of the V phase and V2 is an output of the V phase.

The four rows below the position markings correspond, for example, to four winding layers of the lamination stack with the winding. The uppermost winding layer in the table corresponds, by way of example, to inner layer L1. The second winding layer is arranged below inner layer L1 in the table shown here and is meant as the intermediate layer L2 arranged in the lamination stack radially adjacent inner layer L1. Similarly, the row below this designates the further intermediate layer L3 which is arranged radially adjacent the second intermediate layer L2, and the row below that designates the outer layer L4 arranged radially adjacent the further intermediate layer L3. Two different twist directions T1, T2 are associated with the individual winding layers L1, L2, L3, L4. A first twist direction T1 and a second twist direction T2 are associated with inner layer L1 and outer layer L4, respectively. Only the first twist direction T1 which, merely by way of example, is directed toward the left in the diagram shown here is associated with intermediate layer L2, and the second twist direction T2 running opposite the first twist direction T1 is associated with further intermediate layer L3. Inputs and outputs of the partial strands of the winding proceeding from a twist side of the winding are marked in the bottom row of the winding scheme 400.

In the exemplary embodiment shown here, winding scheme 400 is represented, merely illustratively, based on a winding of the U phase. The remaining windings are windable according to the same scheme.

In one aspect of the invention, a first partial strand a1 of the winding is arranged with the first input portion in a first input slot as was described referring to the preceding FIG. 1. The first input slot is positioned, by way of example, at a first input position 40 of a first input layer. In this exemplary embodiment, the first input layer corresponds to inner layer L1 with which both first twist direction T1 and second twist direction T2 of the winding are associated.

The first output portion of partial strand a1 is arranged in a first output slot which is positioned at a first output position 33 in intermediate layer L2. The first input portion and the first output portion are radially spaced along the circumference of winding layers L1, L2, since six other positions for other partial strands are arranged between first input position 40 and first output position 33.

In this exemplary aspect of the invention, the first output portion of first partial strand a1 is interconnected with a second input portion of a second partial strand a2. For this purpose, the second input portion of second partial strand a2 is arranged in a second input slot which is positioned at a second input position 40 in further intermediate layer L3. The second input position 40 corresponds, merely by way of example, to the first input position 40 with respect to the positioning along the circumference. The first input portion of partial strand a1 and the second input portion of partial strand a2 are radially spaced from one another within the same slot. The second input portion is interconnected with the first output portion by, e.g., 3.5 twist steps. This means that the first output portion is guided over 3.5 positions in first twist direction T1 to the second input portion, and the second input portion is guided over 3.5 positions in second twist direction T1 to the first output portion in order for both to be coupled with one another, e.g., so as to be electrically conductive.

In this exemplary aspect of the invention, second partial strand a2 is guided parallel to first partial strand a1. To this end, the second output portion of second partial strand a2 is arranged in a second output slot at a second output position 33 corresponding, by way of example, to the first output position 33. However, the second output portion is arranged so as to be radially spaced from the first output portion in outer layer L4.

In this exemplary aspect of the invention, second partial strand a2 is interconnected with a further first partial strand A3. For this purpose, the second output portion of second partial strand a2 is interconnected with a further first input portion of further first partial strand A3, and the further first input portion is arranged in a further first input slot at a further first input position 24 in outer layer L4. The second output portion is interconnected with the further first input portion by, e.g., 4.5 twist steps. This means that the second output portion is guided to the further first input portion over 4.5 positions in the second twist direction T2, and the further first input portion is guided to the second output portion over 4.5 positions in the first twist direction T1 in order to couple both of them together, e.g., so as to be electrically conductive. An interconnection of partial strands a2, A3 within outer layer L4 is possible because oppositely directed twist directions T1, T2 are associated with outer layer L4.

In this exemplary aspect of the invention, further first partial strand A3 is guided from the further first input position 24 in outer layer L4 to a further first output position 31 in a further first output slot in further intermediate layer L3. Accordingly, further first partial strand A3 is guided along the circumference so as to be spaced from, but parallel to, the second partial strand a2. Further first partial strand A3 is again, merely by way of example, interconnected with a further second partial strand A4, the further second partial strand A4 being guided so as to be spaced from and parallel to the first partial strand a1. In this exemplary aspect of the invention, further second partial strand A4 is interconnected with additional first partial strand a5 inside inner layer L1. In this exemplary embodiment, merely illustratively, thirty-six partial strands are guided in positions arranged so as to be spaced from one another along the circumference of winding layers L1, L2, L3, L4 according to the above-described pattern and are alternately interconnected with one another. In this case, the partial strands span, merely by way of example, winding layers adjacent one another, respectively.

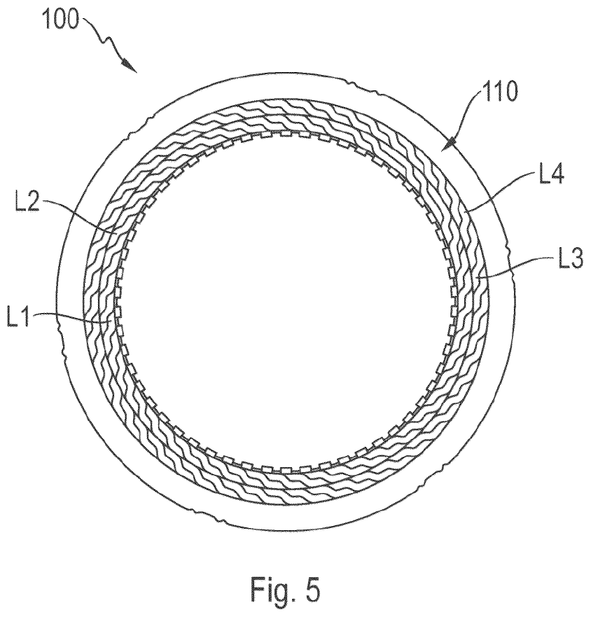

FIG. 5 shows a schematic top view of a component 100 with a winding 110. The component 100 and winding 110 shown in FIG. 5 correspond to, or are similar to, the component and winding described with reference to the preceding FIGS. 1 to 3. In the view depicted here, component 100 is shown from the crown side of the component. In this exemplary aspect of the invention, the partial strands of winding 110 are wound, by way of example, according to the winding scheme described in the preceding FIG. 4 and correspondingly partially span inner layer L1 with adjacently arranged intermediate layer L2 and outer layer L4 with adjacently arranged further intermediate layer L3. On the twist side that is not visible in this diagram, interconnections are arranged, respectively, within inner layer L1, within outer layer L4 and between intermediate layer L2 and further intermediate layer L3.

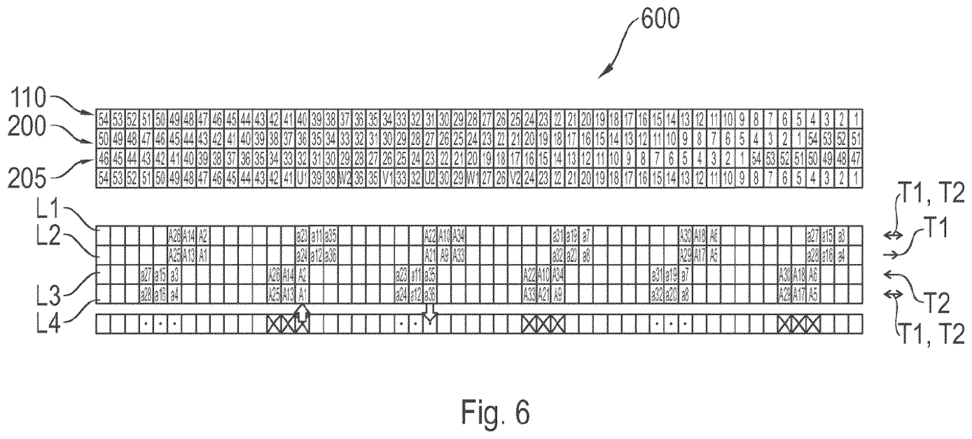

FIG. 6 shows a tabular representation of an exemplary aspect of the invention of a further winding scheme 600 for a winding such as that described in the preceding FIGS. 1 to 3. The further winding scheme 600 shown here is carried out, by way of example, for a component with a lamination stack with, by way of example, fifty-four slots and a respective hole number 3 for receiving a total of three windings 110, 200, 205 in which, by way of example, phases U, W and V can be carried. Positions 1 to 54 of the slots along the circumference of the lamination stack are indicated in the top three rows of the table. The top row corresponds to the winding 110 carrying the U phase, the row below that corresponds to the further winding 200 carrying the W phase, and the row below that corresponds to the additional winding 205 carrying the V phase. The positions of the respective connections of the individual phases are indicated in the fourth row, where U1 designates an input of the U phase and U2 designates an output of the U phase, W1 designates an input of the W phase and W2 indicates an output of the W phase, and V1 designates an input of the V phase and V2 designates an output of the V phase.

The four rows below the position markings correspond, by way of example, to four winding layers of the lamination stack with the winding. The top winding layer in the table corresponds, by way of example, to inner layer L1. The second winding layer is arranged below inner layer L1 in the table and designates intermediate layer L2 arranged radially adjacent inner layer L1 in the lamination stack. The row below that similarly designates further intermediate layer L3 which is arranged radially adjacent second intermediate layer L2, and the row below that designates outer layer L4 which is arranged radially adjacent further intermediate layer L3. Two different twist directions T1, T2 are associated with the individual winding layers L1, L2, L3, L4. Accordingly, a first twist direction T1 and a second twist direction T2 are associated in each instance with the inner layer L1 and the outer layer L4. Only the first twist direction T1 which, merely by way of example, is directed toward the right in the diagram shown here is associated with intermediate layer L2, and the second twist direction T2 running opposite the first twist direction T1 is associated with further intermediate layer L3. Inputs and outputs of the partial strands of the winding proceeding from a twist side of the winding are indicated in the bottom row of the further winding scheme 600.

In the exemplary aspect of the invention shown here, further winding scheme 600 is shown based, merely by way of example, on a winding of the U phase. The rest of the windings are windable according to the same pattern.

As in the winding scheme shown in the preceding FIG. 4, further winding scheme 600 shown here has a first partial strand A1 whose first input portion is arranged in a first input slot. The first input slot is positioned at a first input position 40 of a first input layer. In this exemplary embodiment, the first input layer corresponds to outer layer L4 with which the first twist direction T1 and second twist direction T2 of the winding are associated.

First partial strand A1 of the further winding scheme 600 shown here has a first output portion which is arranged in a first output slot. The first output slot is positioned, merely by way of example, at a first output position 47 of intermediate layer L2. The first input position 40 is spaced from first output position 47 along the circumference of intermediate layer L2. Accordingly, in this exemplary aspect of the invention, first partial strand A1 is guided through the lamination stack over a plurality of slots or positions along the circumference and so as to span further intermediate layer L3.

First partial strand A1 is interconnected with second partial strand A2. For this purpose, the second input portion of second partial strand A2 is arranged in a second input slot which is positioned at a second input position 40 in further intermediate layer L3. With respect to the positioning along the circumference, the second input position 40 corresponds, by way of example, to first input position 40. The first input portion of partial strand a1 and the second input portion of partial strand a2 are arranged merely radially spaced from one another in, by way of example, adjacent winding layers L3, L4. The second input portion is interconnected with the first output portion with, by way of example, 3.5 twist steps. This means that the first output portion is guided to the second input portion in first twist direction T1 over 3.5 positions, and the second input portion is guided to the first output portion in second twist direction T1 over 3.5 positions in order to couple them with one another, by way of example, so as to be electrically conductive.

In this exemplary aspect of the invention, second partial strand A2 spans intermediate layer L2 and is arranged with a second output portion in a second output slot at a second output position 47 corresponding, by way of example, to first output position 47. The second output portion is arranged so as to be radially spaced from the first output portion in inner layer L1.

In this exemplary aspect of the invention, second partial strand A2 is interconnected with a further first partial strand a3. For this purpose, the second output portion of second partial strand A2 is interconnected with a further first input portion of further first partial strand a3, and the further first input portion is arranged in a further first input slot at a further first input position 2 in outer layer L1. The second output portion is interconnected with the further first input portion by, e.g., 4.5 twist steps. This means that the second output portion is guided to the further first input portion over 4.5 positions in second twist direction T2, and the further first input portion is guided to the second output portion over 4.5 positions in first twist direction T1 in order to couple both of them together, e.g., so as to be electrically conductive. An interconnection of partial strands A2, a3 within outer layer L1 is possible because oppositely directed twist directions T1, T2 are associated with inner layer L1.

In this exemplary aspect of the invention, further first partial strand a3 is guided from further first input position 2 in inner layer L1 to a further first output position 49 in a further first output slot in further intermediate layer L3. Accordingly, further first partial strand a3 is guided along the circumference so as to be spaced from, but parallel to, second partial strand A2. Further first partial strand a3 is again, merely by way of example, interconnected with a further second partial strand a4, and further second partial strand a4 is guided from intermediate layer L2 to outer layer L4 parallel to further first partial strand a3. Further first partial strand a4 is interconnected with an additional first partial strand A5 within outer layer L4. In this exemplary embodiment, merely illustratively, thirty-six partial strands are guided in positions arranged so as to be spaced from one another along the circumference of winding layers L1, L2, L3, L4 according to the above-described pattern and are alternately interconnected with one another. In this case, the partial strands, merely by way of example, alternately span intermediate layer L2 and further intermediate layer L3, respectively.

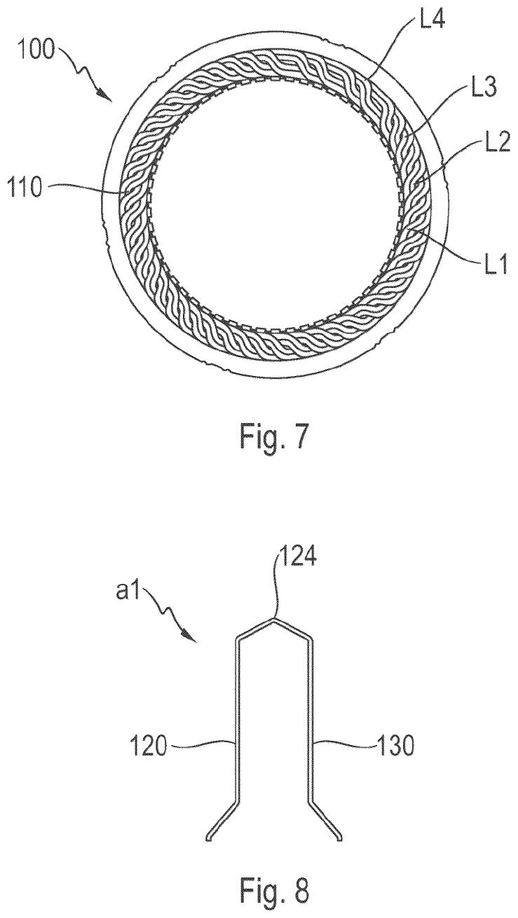

FIG. 7 shows a schematic top view of a component 100 with a winding 110. The component 100 and winding 110 shown in FIG. 7 correspond to, or are similar to, the component and winding described with reference to the preceding FIGS. 1 to 3. In the view depicted here, component 100 is shown from the crown side of the component. In this exemplary aspect of the invention, the partial strands of winding 110 are wound, by way of example, according to the further winding scheme described referring to the preceding FIG. 6 and correspondingly, by way of example, alternately span intermediate layer L2 and further intermediate layer L3, respectively. In other words, the partial strands in this exemplary embodiment are guided, respectively, from outer layer L4 to intermediate layer L2 and from further intermediate layer L3 to inner layer L1, or vice versa. On the twist side, which is not visible in this diagram, interconnections are arranged, respectively, within inner layer L1, within outer layer L4 and between intermediate layer L2 and further intermediate layer L3.

FIG. 8 shows a schematic view of a first partial strand a1. The first partial strand a1 shown here corresponds to, or is similar to, the first partial strand described in the preceding FIGS. 1, 4 and 6 and is insertable in a winding such as was described in the preceding FIGS. 1, 2, 3, 5 and 7. In this exemplary aspect of the invention, first partial strand a1 is formed as a flat wire from a copper material for conducting electrical energy and with a hairpin-like geometry. First partial strand a1 comprises a first input portion 120 and a first output portion 130 for guiding through a slot of a lamination stack of a component. First input portion 120 and first output portion 130 are connected by a first connection portion 124.

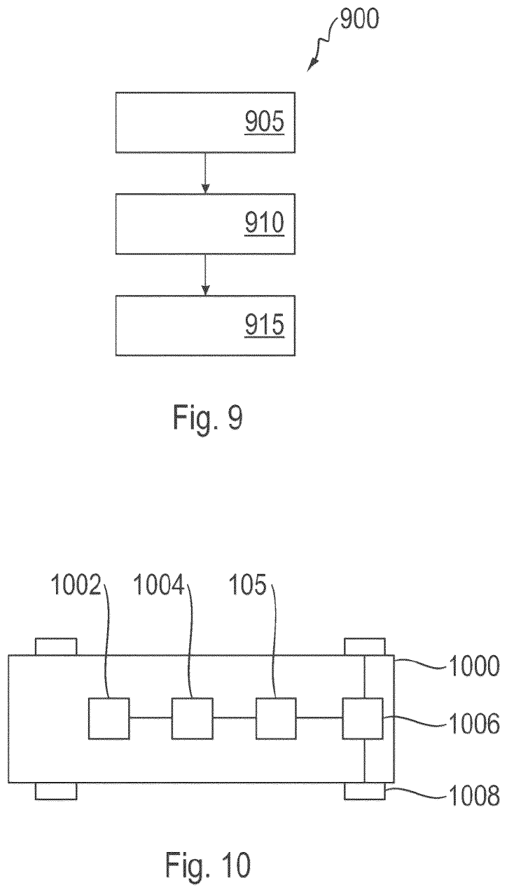

FIG. 9 shows a flowchart for a method 900 for producing a winding. The method 900 comprises a step 905 of guiding the first partial strand of the winding through the intermediate layer, the first twist direction of the winding being associated with the intermediate layer. The method 900 further comprises a step 910 of further guiding the second partial strand through the further intermediate layer. A second twist direction of the winding which differs from the first twist direction is associated with the further intermediate layer. Method 900 further comprises a step 915 of interconnecting the first partial strand and the second partial strand. Merely by way of example, the partial strands are electrically conductively connected to one another in step 915 of interconnecting.

FIG. 10 shows a motor vehicle 1000. Motor vehicle 1000 has an electric axle drive with an electric machine 105 such as that described by way of example referring to the preceding figures. Electrical energy for the operation of the electric machine 105 is supplied by a power supply device 1002, for example, a battery. For example, a DC current provided by the power supply device 1002 is converted into AC current, for example, a three-phase AC current, using a power converter 1004 of the transmission device and is supplied to the electric machine 105. A shaft driven by electric machine 105 is coupled directly or using a transmission device 1006 to at least one wheel 1008 of motor vehicle 1000. Accordingly, motor vehicle 1000 can be moved using electric machine 105. According to an exemplary aspect of the invention, the electric axle drive comprises a housing in which the power converter 1004, the electric machine 105 and the transmission device 1006 are integrated.

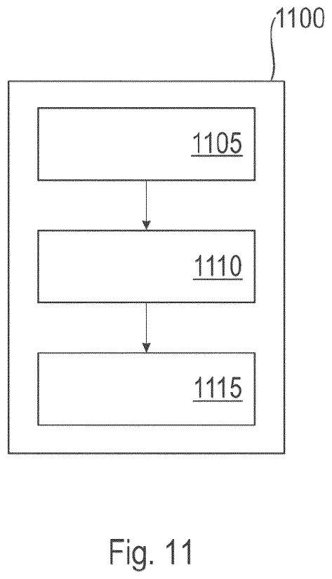

FIG. 11 shows a block diagram of an exemplary embodiment of an apparatus 1100 for producing a winding in accordance with a variant presented herein. Apparatus 1100 comprises a guide-through unit 1105 for controlling a guiding of the first partial strand of the winding through the intermediate layer and a further guide-through unit 1110 for controlling a further guiding of the second partial strand through the further intermediate layer. Apparatus 1100 further comprises an interconnection unit 1115 for controlling an interconnection of the first partial strand and second partial strand.

The exemplary aspects of the invention described herein and shown in the figures are selected only by way of example. Different exemplary embodiments can be combined with one another, either in their entirety or with respect to individual features.

Furthermore, the method steps according to the invention can be repeated and carried out in a sequence other than the sequence described.

When an exemplary embodiment includes an “and/or” conjunction between a first feature and a second feature, this can be read to mean that the exemplary embodiment has both the first feature as well as the second feature according to one embodiment, and has either just the first feature or just the second feature according to another embodiment.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A winding for a component of an electric machine, wherein the component comprises:
an annular lamination stack with a plurality of slots axially extending through the lamination stack configured to receive partial strands of the winding in a plurality of winding layers arranged radially adjacent one another,
wherein
a first twist direction and a second twist direction that differs from the first twist direction are associated with a radially innermost inner layer of the winding layers,
the first twist direction and second twist direction are associated with a radially outermost outer layer of the winding layers,
the first twist direction is associated with at least one intermediate layer of the winding layers arranged radially between the inner layer and the outer layer, and
the second twist direction is associated with at least one further intermediate layer of the winding layers arranged radially between the inner layer and the outer layer,
wherein a first partial strand of the winding exiting from the intermediate layer is interconnected with a second partial strand of the winding entering in the further intermediate layer.

17. The winding according to claim 16, wherein the first partial strand comprises:
a first input portion arranged in a first input slot of the slots at a first input position of a first input layer of the winding layers;
a first output portion arranged in a first output slot of the slots at a first output position of the intermediate layer; and
a first connection portion connecting the first input portion and the first output portion,
wherein the first input layer corresponds to a winding layer of the winding layers which differs from the intermediate layer, and the first input position is spaced from the first output position along a circumference of a winding layer,
wherein the first output portion is interconnected with the second partial strand.

18. The winding according to claim 17, wherein the first input layer and the intermediate layer are arranged adjacent one another.

19. The winding according to claim 17, wherein the further intermediate layer is arranged between the first input layer and intermediate layer.

20. The winding according to claim 17, wherein the second partial strand comprises:
a second input portion arranged in a second input slot at a second input position of the further intermediate layer and is interconnected with the first output portion of the first partial strand;
a second output portion arranged in a second output slot at a second output position of the outer layer or of the inner layer; and
a second connection portion connecting the second input portion and the second output portion,
wherein the second input position is spaced from the second output position along a circumference of a winding layer, and
wherein the second output portion is connected with a further first input portion of a further partial strand.

21. The winding according to claim 20,
wherein a further first input portion of a further first partial strand is arranged in a further first input slot at a further first input position (24; 2),
wherein the further first input position (24; 2) is spaced from the second output position along the circumference of one of the winding layers.

22. The winding according to claim 16, wherein the winding comprises a plurality of first and second partial strands which are alternately interconnected with one another.

23. A component for an electric machine comprising:
a winding and
an annular lamination stack with a plurality of slots axially extending through the lamination stack configured to receive partial strands of the winding in a plurality of winding layers arranged radially adjacent one another,
wherein
a first twist direction and a second twist direction that differs from the first twist direction are associated with a radially innermost inner layer of the winding layers,
the first twist direction and second twist direction are associated with a radially outermost outer layer of the winding layers,
the first twist direction is associated with at least one intermediate layer of the winding layers arranged radially between the inner layer and the outer layer, and
the second twist direction is associated with at least one further intermediate layer of the winding layers arranged radially between the inner layer and the outer layer,
wherein a first partial strand of the winding exiting from the intermediate layer is interconnected with a second partial strand of the winding entering in the further intermediate layer.

24. The component according to claim 23, wherein the component comprises three windings.

25. An electric machine comprising:
a component comprising:
a winding and
an annular lamination stack with a plurality of slots axially extending through the lamination stack configured to receive partial strands of the winding in a plurality of winding layers arranged radially adjacent one another,
wherein
a first twist direction and a second twist direction that differs from the first twist direction are associated with a radially innermost inner layer of the winding layers,
the first twist direction and second twist direction are associated with a radially outermost outer layer of the winding layers,
the first twist direction is associated with at least one intermediate layer of the winding layers arranged radially between the inner layer and the outer layer, and
the second twist direction is associated with at least one further intermediate layer of the winding layers arranged radially between the inner layer and the outer layer,
wherein a first partial strand of the winding exiting from the intermediate layer is interconnected with a second partial strand of the winding entering in the further intermediate layer,
wherein the component is constructed as stator or rotor of an electric machine and comprises three windings.

26. An electric axle drive for a motor vehicle comprising:
a transmission device;
a power converter; and
at least one electric machine, having a component comprising:
a winding and
an annular lamination stack with a plurality of slots axially extending through the lamination stack configured to receive partial strands of the winding in a plurality of winding layers arranged radially adjacent one another,
wherein
a first twist direction and a second twist direction that differs from the first twist direction are associated with a radially innermost inner layer of the winding layers,
the first twist direction and second twist direction are associated with a radially outermost outer layer of the winding layers,
the first twist direction is associated with at least one intermediate layer of the winding layers arranged radially between the inner layer and the outer layer, and
the second twist direction is associated with at least one further intermediate layer of the winding layers arranged radially between the inner layer and the outer layer,
wherein a first partial strand of the winding exiting from the intermediate layer is interconnected with a second partial strand of the winding entering in the further intermediate layer,
wherein the component is constructed as stator or rotor and comprises three windings.

27. A method for producing a winding having a first twist direction and a second twist direction that differs from the first twist direction are associated with a radially innermost inner layer of the winding layers,
the first twist direction and second twist direction are associated with a radially outermost outer layer of the winding layers,
the first twist direction is associated with at least one intermediate layer of the winding layers arranged radially between the inner layer and the outer layer, and
the second twist direction is associated with at least one further intermediate layer of the winding layers arranged radially between the inner layer and the outer layer,
wherein a first partial strand of the winding exiting from the intermediate layer is interconnected with a second partial strand of the winding entering in the further intermediate layer, comprising:
guiding the first partial strand of the winding through the intermediate layer, wherein the first twist direction of the winding is associated with the intermediate layer;
further guiding the second partial strand through the further intermediate layer, wherein a second twist direction of the winding which differs from the first twist direction is associated with the further intermediate layer; and
interconnecting the first partial strand with the second partial strand.

28. An apparatus for producing a winding having a first twist direction and a second twist direction that differs from the first twist direction are associated with a radially innermost inner layer of the winding layers,
the first twist direction and second twist direction are associated with a radially outermost outer layer of the winding layers,
the first twist direction is associated with at least one intermediate layer of the winding layers arranged radially between the inner layer and the outer layer, and
the second twist direction is associated with at least one further intermediate layer of the winding layers arranged radially between the inner layer and the outer layer,
wherein a first partial strand of the winding exiting from the intermediate layer is interconnected with a second partial strand of the winding entering in the further intermediate layer, the apparatus comprising:
a first component configured to guide the first partial strand of the winding through the intermediate layer, wherein the first twist direction of the winding is associated with the intermediate layer;
a second component configured to guide the second partial strand through the further intermediate layer, wherein a second twist direction of the winding which differs from the first twist direction is associated with the further intermediate layer; and
a third component configured to interconnect the first partial strand with the second partial strand.

29. A computer program stored on a nontransitory computer readable medium which is adapted to execute and/or actuate a method for producing a winding having a first twist direction and a second twist direction that differs from the first twist direction are associated with a radially innermost inner layer of the winding layers,
the first twist direction and second twist direction are associated with a radially outermost outer layer of the winding layers,
the first twist direction is associated with at least one intermediate layer of the winding layers arranged radially between the inner layer and the outer layer, and
the second twist direction is associated with at least one further intermediate layer of the winding layers arranged radially between the inner layer and the outer layer,
wherein a first partial strand of the winding exiting from the intermediate layer is interconnected with a second partial strand of the winding entering in the further intermediate layer, comprising:
guiding the first partial strand of the winding through the intermediate layer, wherein the first twist direction of the winding is associated with the intermediate layer;
further guiding the second partial strand through the further intermediate layer, wherein a second twist direction of the winding which differs from the first twist direction is associated with the further intermediate layer; and
interconnecting the first partial strand with the second partial strand.
